(19) United States
(12) Patent Application Publication
(10) Pub. No.: US 2022/0084271 A1
(43) Pub. Date: Mar. 17, 2022

(54) IMAGE PROCESSING METHOD AND DEVICE

(71) Applicant: BEIJING SENSETIME TECHNOLOGY DEVELOPMENT CO., LTD., Beijing (CN)

(72) Inventors: Yujun SHEN, Beijing (CN); Jinjin GU, Beijing (CN); Bolei ZHOU, Beijing (CN)

(21) Appl. No.: 17/536,756

(22) Filed: Nov. 29, 2021

Related U.S. Application Data
(63) Continuation of application No. PCT/CN2019/123682, filed on Dec. 6, 2019.

(30) Foreign Application Priority Data
Jul. 16, 2019 (CN) 201910641159.4

(51) Int. Cl. G06T 11/60; G06T 11/40

(52) U.S. Cl. CPC G06T 11/60; G06T 11/40

(57) ABSTRACT

An image processing method and device. In the method, a vector to be edited in a latent space of an image generative network and a first target decision boundary of a first target attribute in the latent space are acquired. The first target attribute includes a first category and a second category, the latent space is divided into a first subspace and a second subspace by the first target decision boundary, the first target attribute of vectors in the first subspace is of the first category and the first target attribute of vectors in the second subspace is of the second category; the vector to be edited in the first subspace is moved to the second subspace, an edited vector is obtained; and the edited vector is input to the image generative network, and a target image is obtained.

### CROSS-REFERENCE TO RELATED APPLICATIONS

This is a continuation of International Application No. PCT/CN2019/123682, filed on Dec. 6, 2019, and entitled “IMAGE PROCESSING METHOD AND DEVICE”, which is filed based upon and claims priority to Chinese Patent Application No. 201910641159.4, filed on Jul. 16, 2019. The disclosures of International Application No. PCT/CN2019/123682 and Chinese Patent Application No. 201910641159.4 are hereby incorporated by reference in their entireties.

### TECHNICAL FIELD

The application relates to the technical field of image processing, and particularly to an image processing method and device.

### BACKGROUND

A generated image may be obtained through coding a noisy image that is randomly generated, obtaining a noise vector of the noisy image in a latent space, then obtaining a generated image vector corresponding to the noisy vector based on a mapping relationship between a vector in the latent space and a generated image vector, and finally decoding the generated image vector.

The generated image includes multiple attributes, for example, “whether glasses are worn” and “gender”. Each attribute includes multiple categories. For example, the attribute “whether glasses are worn” includes two categories, namely “glasses are worn” and “no glasses are worn”, and the attribute “gender” includes two categories, i.e., “male” and “female”. Under the condition that the same noisy image is input, if a category of an attribute in the generated image is changed, for example, a person wearing glasses in the image is changed to a person without glasses, and a male in the generated image is changed to a female, the mapping relationship between the vector in the latent space and the generated image vector needs to be modified.

### SUMMARY

Embodiments of the disclosure provide an image processing method and device.

According to a first aspect, the embodiments of the disclosure provide an image processing method, which may include that: a vector to be edited in a latent space of an image generative network and a first target decision boundary of a first target attribute in the latent space are acquired, the first target attribute including a first category and a second category, the latent space being divided into a first subspace and a second subspace by the first target decision boundary, the first target attribute of vectors in the first subspace being of the first category and the first target attribute of vectors in the second subspace being of the second category; the vector to be edited in the first subspace is moved to the second subspace and an edited vector is obtained; and the edited vector is input to the image generative network and a target image is obtained.

According to a second aspect, the embodiments of the disclosure further provide an image processing device, which may include: a first acquisition unit, configured to acquire a vector to be edited in a latent space of an image generative network and a first target decision boundary of a first target attribute in the latent space, the first target attribute including a first category and a second category, the latent space being divided into a first subspace and a second subspace by the first target decision boundary, the first target attribute of vectors in the first subspace being of the first category and the first target attribute of vectors in the second subspace being of the second category; a first processing unit, configured to move the vector to be edited in the first subspace to the second subspace and obtain an edited vector; and a second processing unit, configured to input the edited vector to the image generative network and obtain a target image.

According to a third aspect, the embodiments of the disclosure further provide a processor, which is configured to execute the method of the first aspect and any possible implementation mode thereof.

According to a fourth aspect, the embodiments of the disclosure further provide an electronic device, which may include a processor, a sending device, an input device, an output device and a memory. The memory may be configured to store a computer program code. The computer program code may include computer instructions, which, when executed by the processor, cause the electronic device to execute the method of the first aspect and any possible implementation mode thereof.

According to a fifth aspect, the embodiments of the disclosure further provide a computer-readable storage medium, in which a computer program may be stored, the computer program including program instructions, which, when executed by a processor of an electronic device, cause the processor to execute the method of the first aspect and any possible implementation mode thereof.

According to a sixth aspect, the embodiments of the disclosure further provide a computer program product, which may include computer program instructions, which cause a computer to execute the method of the first aspect and any possible implementation mode thereof.

It is to be understood that the above general description and the following detailed description are only exemplary and explanatory and not intended to limit the disclosure.

### BRIEF DESCRIPTION OF THE DRAWINGS

In order to describe the technical solutions in the embodiments of the disclosure or a background art more clearly, the drawings required to be used for descriptions about the embodiments of the disclosure or the background art will be described below.

The accompanying drawings, which are incorporated in and constitute a part of this specification, illustrate embodiments consistent with the disclosure and, together with the specification, serve to describe the technical solutions of the disclosure.

FIG. 1 is a flowchart of an image processing method according to an embodiment of the disclosure.

FIG. 2 is a flowchart of another image processing method according to an embodiment of the disclosure.

FIG. 3 is a schematic diagram of a positive side and negative side of a decision boundary according to an embodiment of the disclosure.

FIG. 4 is a flowchart of another image processing method according to an embodiment of the disclosure.

FIG. 5 is a schematic diagram of projection of a first normal vector to a second normal vector according to an embodiment of the disclosure.

FIG. 6 is a flowchart of another image processing method according to an embodiment of the disclosure.

FIG. 7 is a flowchart of a method for acquiring a first target decision boundary according to an embodiment of the disclosure.

FIG. 8 is a structure diagram of an image processing device according to an embodiment of the disclosure.

FIG. 9 is a hardware structure diagram of an image processing device according to an embodiment of the disclosure.

### DETAILED DESCRIPTION

In order to make the solutions of the application understood by those skilled in the art, the technical solutions in the embodiments of the disclosure will be clearly and completely described below in combination with the drawings in the embodiments of the disclosure. It is apparent that the described embodiments are not all embodiments but only part of embodiments of the disclosure. All other embodiments obtained by those of ordinary skill in the art based on the embodiments in the application without creative work shall fall within the scope of protection of the application.

Terms “first”, “second” and the like in the specification, claims and drawings of the embodiments of the disclosure are adopted not to describe a specific sequence but to distinguish different objects. In addition, terms “include” and “have” and any transformations thereof are intended to cover nonexclusive inclusions. For example, a process, method, system, product or device including a series of steps or units is not limited to the steps or units which have been listed but optionally further includes steps or units which are not listed or optionally further includes other steps or units intrinsic to the process, the method, the product or the device.

“Embodiment” mentioned in the disclosure means that a specific feature, structure or characteristic described in combination with an embodiment may be included in at least one embodiment of the disclosure. Each position where this phrase appears in the specification does not always refer to the same embodiment as well as an independent or alternative embodiment mutually exclusive to another embodiment. It is explicitly and implicitly understood by those skilled in the art that the embodiments described in the disclosure may be combined with other embodiments.

The embodiments of the disclosure will be described below in combination with the drawings in the embodiments of the disclosure.

An image processing method of the embodiments of the disclosure is applied to an image generative network. Exemplarily, a random vector may be input to the image generative network to generate an image (i.e., a generated image) approximate to an image shot by a real camera. For changing a certain attribute of the generated image, for example, changing the gender of a person in the generated image and, for another example, changing whether the person in the generated image wears glasses or not, the image generative network is required to be retrained by conventional means. Based on how to change a certain attribute of the generated image rapidly and efficiently without retraining the image generative network, the application discloses the following embodiments.

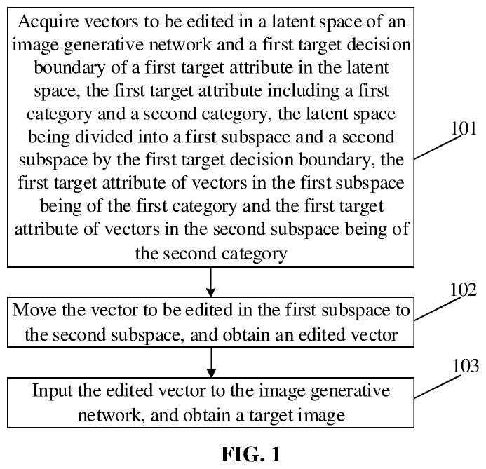

Referring to FIG. 1, FIG. 1 is a flowchart of an image processing method according to an embodiment of the disclosure. The image processing method of the embodiment of the disclosure includes the following steps.

In block 101, a vector to be edited in a latent space of an image generative network and a first target decision boundary of a first target attribute in the latent space are acquired. The first target attribute includes a first category and a second category, the latent space is divided into a first subspace and a second subspace by the first target decision boundary, the first target attribute of vectors in the first subspace is of the first category, and the first target attribute of vectors in the second subspace is of the second category.

In the embodiment, the image generative network may be a generative network in any trained target Generative Adversarial Networks (GANs). A random vector may be input to the image generative network to generate an image (i.e., called a generated image hereinafter) approximate to an image shot by a real camera.

In a training process, the image generative network obtains a mapping relationship in a training learning manner, the mapping relationship representing a mapping relationship between a vector in the latent space and a semantic vector in a semantic space. In a process of obtaining the generated image through the image generative network, the image generative network converts the random vector in the latent space to a semantic vector in the semantic space according to the mapping relationship obtained in the training process, and then codes the semantic vector and obtains the generated image.

In the embodiment of the disclosure, the vector to be edited is any vector in the latent space of the image generative network.

In the embodiment of the disclosure, the first target attribute may include multiple categories. In some implementation modes, the multiple categories of the first target attribute may include the first category and the second category. For example, if the first target attribute is “whether any glasses are worn”, the included first category may be “glasses are worn”, and the second category may be “no glasses are worn”. For another example, if the first target attribute is a gender attribute, the included first category may be “male”, and the second category may be “female”.

In the latent space of the image generative network, each attribute may be considered to implement space division of the latent space of the image generative network, and a decision boundary for space division may be used to divide the latent space into multiple subspaces.

In the embodiment, the first target decision boundary is a decision boundary of the first target attribute in the latent space of the image generative network, the latent space of the image generative network is divided into the first subspace and the second subspace by the first target decision boundary, and attribute categories represented by vectors in different subspaces are different. Exemplarily, the first target attribute of a vector in the first subspace is of the first category, and the first target attribute of a vector in the second subspace is of the second category.

It is to be understood that the above example of the first category and the second category does not mean that only two categories exist; instead, there may be multiple categories, and similarly, the above example of the first subspace and the second subspace does not mean that only two subspaces exist; instead, there may be multiple subspaces.

In an example (example 1), there is made such a hypothesis that, in a latent space of an image generative network 1, a decision boundary of a gender attribute is a hyperplane A, and the hyperplane A divides the latent space of the image generative network 1 into two subspaces, recorded as, for example, a subspace 1 and a subspace 2 respectively. The subspace 1 and the subspace 2 are on two sides of the hyperplane A respectively, an attribute category represented by a vector in the subspace 1 is “male”, and an attribute category represented by a vector in the subspace 2 is “female”.

The “attribute category represented by the vector” refers to an attribute category represented by an image generated by an image generative network based on the vector. Based on the example 1, in another example (example 2), there is made such a hypothesis that a vector a is in the subspace 1 and a vector b is in the subspace 2. In such a case, the gender of a person in an image generated by the image generative network 1 based on the vector a is male, and the gender of a person in an image generated by the image generative network 1 based on the vector b is female.

As described above, each attribute may be considered to implement classification of the latent space of the image generative network, and any vector in the latent space corresponds to an attribute category, so that the vector to be edited may be in any subspace of the latent space with the first target decision boundary.

In the same image generative network, decision boundaries of different attributes are different. In addition, the decision boundary of the attribute in the latent space of the image generative network is determined by the training process of the image generative network, so that decision boundaries of the same attribute in latent spaces of different image generative networks may be different.

Based on the example 2, in another example (example 3), for the image generative network 1, a decision boundary of the attribute “whether glasses are worn” in the latent space is the hyperplane A, but a decision boundary of the gender attribute in the latent space is a hyperplane B. For an image generative network 2, a decision boundary of the attribute “whether glasses are worn” in a latent space is a hyperplane C, but a decision boundary of the gender attribute in the latent space is a hyperplane D. The hyperplane A and the hyperplane C may be the same or may be different, and the hyperplane B and the hyperplane D may be the same or may be different.

In some embodiments, the operation of acquiring the vector to be edited in the latent space of the image generative network may be implemented by receiving the vector to be edited input to the latent space of the image generative network by a user through an input component. The input component includes at least one of a keyboard, a mouse, a touch screen, a touch pad, an audio input device or the like. In some other embodiments, the operation of acquiring the vector to be edited in the latent space of the image generative network may also be implemented by receiving the vector to be edited sent by a terminal and inputting the vector to be edited into the latent space of the image generative network. The terminal includes at least one of a mobile phone, a computer, a tablet computer, a server and the like. In another implementation mode, the vector to be edited may also be obtained by receiving an image to be edited input by the user through the input component or an image to be edited sent by the terminal, coding the image to be edited and inputting a vector obtained by the coding operation to the latent space of the image generative network. A manner for acquiring the vector to be edited is not limited in the embodiment of the disclosure.

In some embodiments, the operation of acquiring the first target decision boundary of the first target attribute in the latent space may include that: the first target decision boundary input by the user through the input component is received, the input component including at least one of a keyboard, a mouse, a touch screen, a touch pad, an audio input unit or the like. In some other embodiments, the operation of acquiring the first target decision boundary of the first target attribute in the latent space may include that: the first target decision boundary sent by the terminal is received, the terminal including at least one of a mobile phone, a computer, a tablet computer, a server or the like.

In block 102, the vector to be edited in the first subspace is moved to the second subspace, and an edited vector is obtained.

As described in block 101, the vector to be edited is in any subspace of the latent space with the first target decision boundary, the first target decision boundary divides the latent space of the image generative network into multiple subspaces, and the attribute categories represented by vectors in different subspaces are different. Therefore, the vector to be edited may be moved from one subspace to another subspace to change the attribute category represented by the vector.

Based on the example 2, in another example (example 4), if the vector a is moved from the subspace 1 to the subspace 2 and a vector c is obtained, an attribute category represented by the vector c is female, and the gender of a person in an image generated by the image generative network 1 based on the vector c is female.

If the first target attribute is a binary attribute (namely the first target attribute includes two categories), the first target decision boundary is a hyperplane in the latent space of the image generative network. In a possible implementation mode, the vector to be edited may be moved from one subspace to another subspace along a normal vector of the first target decision boundary, and the edited vector may be obtained.

In some other possible implementation modes, the vector to be edited may be moved from any subspace to another subspace along any direction.

In block 103, the edited vector is input to the image generative network, and a target image is obtained.

In the embodiment of the disclosure, the image generative network may be obtained by stacking any number of convolutional layers, and convolution is performed on the edited vector through the convolutional layers in the image generative network to implement decoding of the edited vector, thus obtaining the target image.

In a possible implementation mode, the edited vector is input to the image generative network, and the image generative network converts the edited image vector to an edited semantic vector according to the mapping relationship obtained by training (the mapping relationship represents the mapping relationship between the vector in the latent space and the semantic vector in the semantic space), performs convolution on the edited semantic vector and obtains the target image.

In the embodiment, the first target decision boundary of the first target attribute in the latent space of the image generative network divides the latent space of the image generative network into multiple subspaces, and categories of the first target attributes of vectors in different subspaces are different. The vector to be edited in the latent space of the image generative network may be moved from one subspace to another subspace to change the category of the first target attribute of the vector to be edited, and decoding processing is subsequently performed on the moved vector to be edited (i.e., the edited vector) through the image generative network, and the target image of which the category of the first target attribute is changed is obtained. In such a manner, the category of the first target attribute of any image generated by the image generative network may be changed rapidly and efficiently without retraining the image generative network.

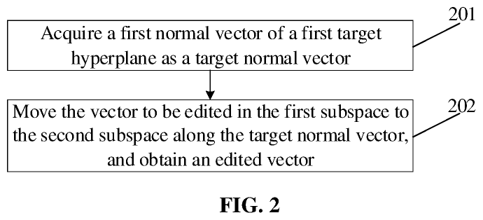

Referring to FIG. 2, FIG. 2 is a flowchart of another image processing method according to an embodiment of the disclosure, specifically a flowchart of a possible implementation mode for 102 in the abovementioned embodiment. The method includes the following steps.

In block 201, a first normal vector of a first target hyperplane is acquired as a target normal vector.

In the embodiment, the first target attribute is a binary attribute (namely the first target attribute includes two categories), the first target decision boundary is the first target hyperplane, the first target hyperplane divides the latent space into two subspaces, the two subspaces correspond to different categories of the first target attribute respectively (referring to the attribute categories “whether glasses are worn” and “gender” in the example 1), and the vector to be edited is in any subspace of the latent space with the first target hyperplane. Based on the example 1, in another example (example 5), there is made such a hypothesis that a vector to be edited d is acquired, the first target attribute is the gender attribute, if the attribute category represented by the vector to be edited is male, the vector to be edited d is in the subspace 1, and if the category represented by the vector to be edited is female, the vector to be edited d is in the subspace 2. That is, the category, represented by the vector to be edited, of the first target attribute determines a position of the vector to be edited in the latent space.

As described in block 102, the vector to be edited may be moved from one subspace to another subspace in the latent space with the first target hyperplane to change the category, represented by the vector to be edited, of the first target attribute (for example, under the condition that the first target attribute is a binary attribute, the vector to be edited is moved from one side of the first target hyperplane to the other side of the first target hyperplane). However, if the movement direction is different, the movement effect is also different. The movement effect includes whether it can be moved from one side of the first target hyperplane to the other side of the first target hyperplane, a movement distance from one side of the first target hyperplane to the other side of the first target hyperplane, and the like.

Therefore, in the embodiment, the normal vector (i.e., the first normal vector) of the first target hyperplane is determined as the target normal vector at first, and the vector to be edited is moved along the target normal vector, so that the vector to be edited may be moved from one side of the first target hyperplane to the other side of the first target hyperplane, and movement along the first normal vector has a shortest movement distance, for the moved vector to be edited to arrive at a same position.

In the embodiment of the disclosure, a positive direction or negative direction of the target normal vector is a movement direction of movement of the vector to be edited from one side of the first target hyperplane to the other side of the first target hyperplane. In the embodiment, the target normal vector is the first normal vector.

Optionally, the acquired first target hyperplane may be an expression of the first target hyperplane in the latent space of the image generative network, and then the first normal vector is calculated according to the expression.

In block 202, the vector to be edited in the first subspace is moved to the second subspace along the target normal vector, and the edited vector is obtained.

In the embodiment, a direction of the target normal vector includes the positive direction of the target normal vector and the negative direction of the target normal vector. For moving the vector to be edited along the target normal vector to implement movement from one side of the first target hyperplane to the other side of the first target hyperplane, before the vector to be edited is moved, it is judged whether a subspace that the vector to be edited points to is the same as the subspace that the target normal vector points to, to further determine to move the vector to be edited along the positive direction of the target normal vector or along the negative direction of the target normal vector.

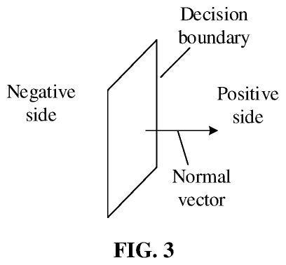

In a possible implementation mode, as shown in FIG. 3, it is defined that the side where the subspace that the positive direction of the normal vector of the decision boundary points to is located is a positive side and the side where the subspace that the negative point of the normal vector of the decision boundary points to is located is a negative side. An inner product of the vector to be edited and the target normal vector is compared with a threshold value. Under the condition that the inner product of the vector to be edited and the target normal vector is greater than the threshold value, it indicates that the vector to be edited is on the positive side of the first target hyperplane (namely the vector to be edited is in the subspace that the target normal vector points to), and the vector to be edited is to be moved along the negative direction of the target normal vector to implement movement of the vector to be edited from one side of the first target hyperplane to the other side. Under the condition that the inner product of the vector to be edited and the target normal vector is less than the threshold value, it indicates that the vector to be edited is on the negative side of the first target hyperplane (namely the vector to be edited is in the subspace that the negative direction of the target normal vector points to), and the vector to be edited is to be moved along the positive direction of the target normal vector to implement movement of the vector to be edited from one side of the first target hyperplane to the other side. Optionally, the threshold value is 0.

In the embodiment, all attributes are considered as binary attributes (namely each attribute includes two categories). However, in a practical scenario, some attributes are not strictly binary attributes, and such an attribute not only includes two categories, but also has degree differences (called a degree attribute hereinafter) in different images.

In an example (example 5), an attribute “old” or “young” includes only two categories “old” and “young”, but “degrees of oldness” and “degrees of youth” of different persons in images are different. The “degree of oldness” and the “degree of youth” may be understood as the age. If the “degree of oldness” is higher, the age is larger, and if the “degree of youth” is higher, the age is smaller. A decision boundary of the attribute “old” and “young” divides people in all age groups to the two categories “old” and “young”. For example, if an age group of persons in an image is 0 to 90, the decision boundary of the attribute “old” and “young” divides the persons that are 40 years old or above to the category “old” and divides the persons that are under 40 to the category “young”.

For the degree attribute, a distance from the vector to be edited to the decision boundary (i.e., the hyperplane) may be regulated to regulate the “degree” finally represented by the attribute in the image.

Based on the example 5, in another example (example 6), it is defined that a distance from the vector to be edited to the hyperplane under the condition that the vector to be edited is on the positive side of the hyperplane is a positive distance and a distance from the vector to be edited to the hyperplane under the condition that the vector to be edited is on the negative side of the hyperplane is a negative distance. There is made such a hypothesis that a hyperplane of the attribute “old” or “young” in a latent space of an image generative network 3 is E, an attribute category represented by a positive side of the hyperplane E is “old”, an attribute category represented by a negative side of the hyperplane E is “young”, a vector to be edited e is input to the latent space of the image generative network 3, and the vector to be edited e is on the positive side of the hyperplane E. The vector to be edited e is moved to prolong a positive distance from the vector to be edited e to the hyperplane E to increase the “degree of oldness” represented by the vector to be edited e (namely increasing the age), and the vector to be edited e is moved to prolong a negative distance from the vector to be edited e to the hyperplane E to increase the “degree of youth” represented by the vector to be edited e (namely decreasing the age).

In a possible implementation mode, the vector to be edited in the first subspace is moved to the second subspace along the target normal vector and to be at a distance of a preset value from the first target hyperplane, such that the obtained edited vector represents a specific degree of the category of the first target attribute. Based on the example 6, in another example (example 7), there is made such a hypothesis that a represented age is 25 when the negative distance from the vector to be edited e to the hyperplane E is 5 to 7, and if the user needs to ensure that the age of a person in the target image is 25, the vector to be edited e may be moved at the negative distance of any numerical value from 5 to 7 to the hyperplane E.

In the embodiment, the first target attribute is a binary attribute (namely the first target attribute includes the two categories), and the vector to be edited is moved along the first normal vector of the decision boundary (the first target hyperplane) of the first target attribute in the latent space of the image generative network, so that a movement distance of the vector to be edited may be shortest, and it may be ensured that the vector to be edited is moved from one side of the first target hyperplane to the other side, thus rapidly changing the category of the first target attribute of the vector to be edited. When the first target attribute is the degree attribute, the distance from the vector to be edited to the first target hyperplane may be regulated to regulate the “degree” of the first target attribute of the vector to be edited, thereby further changing the “degree” of the first target attribute in the target image.

The first target attribute described in the embodiment of the disclosure is an uncoupled attribute, namely the vector to be edited may be moved from the first subspace to the second subspace to change the category represented by the first target attribute without changing a category represented by another attribute in the vector to be edited. However, there may also be coupled attributes in the latent space of the image generative network, namely when the vector to be edited is moved from the first subspace to the second subspace to change the category represented by the first target attribute, the category represented by an attribute coupled with the first target attribute is also changed.

In some embodiments (example 7), the attribute “whether glasses are worn” and the attribute “old or young” are coupled attributes, and when the vector to be edited is moved to change the attribute category, represented by the vector to be edited, of whether glasses are worn from the category “glasses are worn” to the category “no glasses are worn”, the attribute category “old” or “young” represented by the vector to be edited may also be changed from the category “old” to the category “young”.

Therefore, under the condition that the first target attribute has a coupled attribute, a decoupling method is required to avoid the category of the attribute coupled with the first target attribute from being changed when the vector to be edited is moved to change the category of the first target attribute.

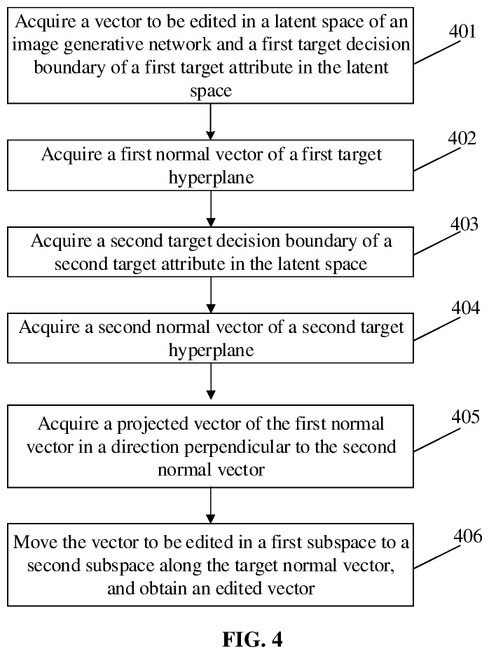

Referring to FIG. 4, FIG. 4 is a flowchart of another image processing method according to an embodiment of the disclosure. The method includes the following steps.

In block 401, a vector to be edited in a latent space of an image generative network and a first target decision boundary of a first target attribute in the latent space are acquired.

This step refers to the detailed descriptions about block 101 and will not be elaborated herein.

In block 402, a first normal vector of a first target hyperplane is acquired.

This step refers to the detailed descriptions about 201 and will not be elaborated herein.

In block 403, a second target decision boundary of a second target attribute in the latent space is acquired.

In the embodiment, the second target attribute may have a coupled relationship with the first target attribute, and the second target attribute includes a third category and a fourth category. The second target decision boundary may be a second target hyperplane, and the second target hyperplane divides the latent space of the image generative network into a third subspace and a fourth subspace. The second target attribute of a vector in the third subspace is the third category, and the second target attribute of a vector in the fourth subspace is the fourth category.

A manner for acquiring the second decision boundary may refer to the manner for acquiring the first decision boundary in block 101 and will not be elaborated herein.

Optionally, the second target decision boundary may be acquired at the same time of acquiring the first target decision boundary. A sequence of acquisition of the first decision boundary and acquisition of the second decision boundary is not limited in the embodiment of the disclosure.

In block 404, a second normal vector of a second target hyperplane is acquired.

This step refers to the detailed descriptions about acquisition of the first normal vector of the first target hyperplane in block 201 and will not be elaborated herein.

In block 405, a projected vector of the first normal vector in a direction perpendicular to the second normal vector is acquired.

All attributes in the embodiment are binary attributes, so that a decision boundary of each attribute in the latent space of the image generative network is a hyperplane. When different attributes have a coupled relationship, hyperplanes of different attributes are not in parallel but are intersected. Therefore, under the condition that a category of any attribute is changed, a category of another attribute coupled with the attribute is to be avoided from being changed, the vector to be edited may be moved from one side of the hyperplane of the attribute to the other side of the hyperplane of the attribute, and the vector to be edited is not moved from one side of the hyperplane of the another attribute coupled with the attribute to the other side of the hyperplane.

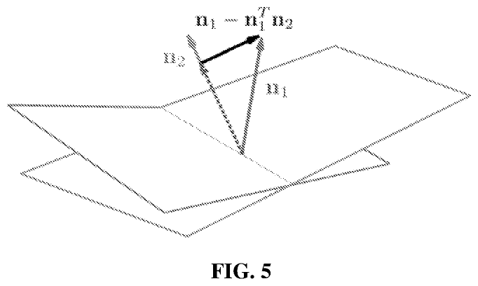

Therefore, in the embodiment, the projected vector of the first normal vector in the direction perpendicular to the second normal vector is determined as a movement direction of the vector to be edited, namely the projected vector is determined as a target normal vector. Referring to FIG. 5, n₁ is the first normal vector, n₂ is the second normal vector, n₁ is projected to a direction of n₂, and the projection direction is n₁−n₁^{T}n₂ (i.e., the projected vector). Since n₁−n₁^{T}n₂ is perpendicular to n₂ and n₁−n₁^{T}n₂ is parallel to the second target hyperplane, moving the vector to be edited along the direction of n₁−n₁^{T}n₂ may avoid movement of the vector to be edited from one side of the second target hyperplane to the other side of the second target hyperplane, but may ensure that the vector to be edited is moved from one side of the first target hyperplane to the other side of the first target hyperplane.

It is to be noted that, in the embodiment, if the first target attribute does not have a coupled relationship with the second target attribute, the target normal vector obtained by operations of blocks 401 to 405 is the first normal vector or the second normal vector.

In block 406, the vector to be edited in a first subspace is moved along the target normal vector to a second subspace, and an edited vector is obtained.

After the target normal vector is determined, the vector to be edited may be moved along the target normal vector to ensure that the vector to be edited in the first subspace is moved to the second subspace, and the edited vector may be obtained.

Based on the example 7, in another example (example 8), both the attribute “whether glasses are worn” and the attribute “old and young” are coupled attributes, a decision boundary of the attribute “whether glasses are worn” in the latent space of the image generative network is a hyperplane F, a decision boundary of the attribute “old and young” in the latent space of the image generative network is a hyperplane G, a normal vector of the hyperplane F is n₃, and a normal vector of the hyperplane G is n₄. If it is desired to change the category, represented by a vector to be edited f in the latent space of the image generative network, of the attribute “whether glasses are worn” without changing the category, represented by the vector to be edited f, of the attribute “old and young”, the vector to be edited f may be moved along n₃−n₃^{T}n₄. If it is desired to change the category, represented by a vector to be edited f in the latent space of the image generative network, of the attribute “old and young” without changing the category, represented by the vector to be edited f, of the attribute “whether glasses are worn”, the vector to be edited f may be moved along n₄−n₃^{T}n₄.

In the embodiment, a projection direction between normal vectors of decision boundaries of mutually coupled attributes in the latent space of the image generative network is determined as the movement direction of the vector to be edited, which may reduce the probability that when the vector to be edited is moved to change a category of any attribute in the vector to be edited, a category of another attribute coupled with the attribute in the vector to be edited is also changed. Based on the method provided in the embodiment, it may be ensured that when the category of any attribute in an image generated by the image generative network is changed, all contents except the category of the attribute (the changed attribute) are not changed.

The image generative network may be configured to obtain a generated image. However, if quality of the generated image is low, the fidelity of the generated image is low. The quality of the generated image is determined by factors such as a resolution of the generated image, richness of detailed information and richness of texture information. Specifically, if the resolution of the generated image is higher, the quality of the generated image is higher; if the richness of the detailed information of the generated image is higher, the quality of the generated image is higher; and if the richness of the texture information of the generated image is higher, the quality of the generated image is higher. In the embodiment of the disclosure, the quality of the generated image is also considered as a binary attribute (called a quality attribute hereinafter). Like the image content attributes (for example, the attribute “whether glasses are worn” and the attribute “gender”, called content attributes hereinafter) in the abovementioned embodiment, the vector to be edited may be moved in the latent space of the image generative network to improve the image quality represented by the vector to be edited.

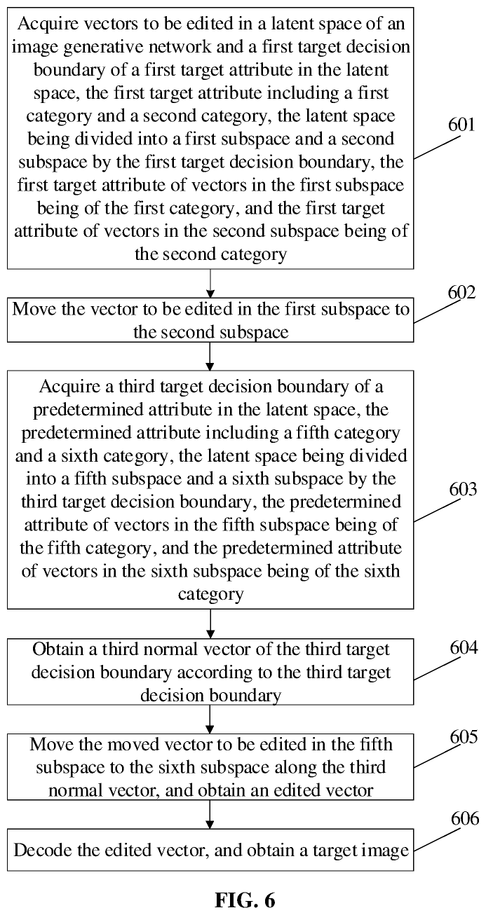

Referring to FIG. 6, FIG. 6 is a flowchart of another image processing method according to an embodiment of the disclosure. The method includes the following steps.

In block 601, a vector to be edited in a latent space of an image generative network and a first target decision boundary of a first target attribute in the latent space are acquired. The first target attribute includes a first category and a second category, the latent space is divided into a first subspace and a second subspace by the first target decision boundary, the first target attribute of vectors in the first subspace is of the first category, and the first target attribute of vectors in the second subspace is of the second category.

This step refers to the detailed descriptions about block 101 and will not be elaborated herein.

In block 602, the vector to be edited in the first subspace is moved to the second subspace.

The process of moving the vector to be edited in the first subspace to the second subspace refers to the detailed descriptions about block 102 and will not be elaborated herein. It is to be noted that, in the embodiment, moving the vector to be edited in the first subspace to the second subspace does not result in an edited vector but a moved vector to be edited.

In block 603, a third target decision boundary of a predetermined attribute in the latent space is acquired. The predetermined attribute includes a fifth category and a sixth category, the latent space is divided into a fifth subspace and a sixth subspace by the third target decision boundary, the predetermined attribute of vectors in the fifth subspace is of the fifth category, and the predetermined attribute of vectors in the sixth subspace is of the sixth category.

In the embodiment, the predetermined attribute includes a quality attribute, and the fifth category and the sixth category are high quality and low quality respectively (for example, the fifth category is high quality and the sixth category is low quality, or the sixth category is high quality and the fifth category is low quality). Image quality represented by high quality is high, and image quality represented by low quality is low. The third decision boundary may be a hyperplane (called a third target hyperplane hereinafter), namely the third target hyperplane divides the latent space of the image generative network into the fifth subspace and the sixth subspace. The predetermined attribute of the vector in the fifth subspace is of the fifth category, and the predetermined attribute in the sixth subspace is of the sixth category. The moved vector obtained by block 602 is located in the fifth subspace.

It is to be understood that, regarding the moved vector to be edited in the fifth subspace, it may indicate that the predetermined attribute represented by the moved vector to be edited is high quality or may indicate that the predetermined attribute represented by the moved vector to be edited is low quality.

In block 604, a third normal vector of the third target decision boundary is obtained according to the third target decision boundary.

This step refers to the detailed descriptions about acquisition of the first normal vector of the first target hyperplane in block 201 and will not be elaborated herein.

In block 605, a moved vector to be edited in the fifth subspace is moved along the third normal vector to the sixth subspace, and an edited vector is obtained.

In the embodiment, the image quality attribute does not have a coupled relationship with any content attribute, and thus moving the vector to be edited from the first subspace to the second subspace may not change the category of the image quality attribute. After the moved image vector is obtained, the moved vector may be moved from the fifth subspace to the sixth subspace along the third normal vector, to change the category of the image quality attribute of the vector to be edited.

In block 606, the edited vector is decoded, and a target image is obtained.

This step refers to the detailed descriptions about block 103 and will not be elaborated herein.

In the embodiment, the quality of an image generated by the image generative network is considered as an attribute, and the vector to be edited is moved from one side of the third target hyperplane to the other side of the third target hyperplane along the normal vector of the decision boundary (the third target hyperplane) of the image quality attribute in the latent space of the image generative network, so that the fidelity of the obtained target image may be improved.

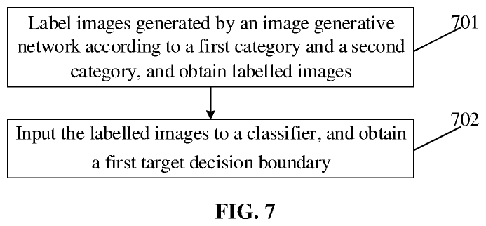

Referring to FIG. 7, FIG. 7 is a flowchart of a method for acquiring a first target decision boundary according to an embodiment of the disclosure. The method includes the following steps.

In block 701, images generated by an image generative network are labelled according to a first category and a second category, and labelled images are obtained.

In the embodiment, meanings of the first category, the second category and the image generative network may refer to block 101. The image generated by the image generative network refers to an image obtained by inputting a random vector to the image generative network. It is to be noted that the image generated by the image generative network includes a first target attribute.

In some embodiments (example 9), the first target attribute is an attribute “whether glasses are worn”, and in such a case, the images generated by the image generative network are required to include one or more images in which glasses are worn and one or more images in which no glasses are worn.

In the embodiment, labelling the images generated by the image generative network according to the first category and the second category refers to distinguishing content of the images generated by the image generative network according to the first category and the second category and labelling the images generated by the image generative network.

Based on the example 9, in some embodiments (example 10), if a label corresponding to the category “no glasses are worn” is 0 and a label corresponding to the category “glasses are worn” is 1, the images generated by the image generative network include an image a, an image b, an image c and an image d, persons in the image a and the image c wear glasses, and persons in the image b and the image d do not wear glasses. Accordingly, the image a and the image c may be labelled to be “1” and the image b and the image d may be labelled to be “0”, and the labelled image a, the labelled image b, the labelled image c and the labelled image d may be obtained.

In 702, the labelled images are input to a classifier, and a first target decision boundary is obtained.

In the embodiment, a linear classifier may code the input labelled images, obtain vectors of the labelled images, then classify vectors of all labelled images according to the labels of the labelled images, and obtain the first target decision boundary.

Based on the example 10, in some embodiments (example 11), the labelled image a, the labelled image b, the labelled image c and the labelled image d are input to the linear classifier and processed by the linear classifier, and a vector of the labelled image a, a vector of the labelled image b, a vector of the labelled image c and a vector of the labelled image d are obtained. Then, a hyperplane is determined according to labels of the image a, the image b, the image c and the image d (the labels of the image a and the image c are 1 and the labels of the image b and the image d are 0) to divide the vector of the labelled image a, the vector of the labelled image b, the vector of the labelled image c and the vector of the labelled image d into two categories. The vector of the labelled image a and the vector of the labelled image c are on a same side of the hyperplane, the vector of the labelled image b and the vector of the labelled image d are on a same side of the hyperplane, and the vector of the labelled image a and the vector of the labelled image b are on different sides of the hyperplane.

It is to be understood that an execution body of the embodiment may be different from or the same as an execution body of the abovementioned embodiments.

For example, images obtained by labelling images generated by an image generative network 1 according to the categories “glasses are worn” and “no glasses are worn” are input to a terminal 1, and the terminal 1 may determine a decision boundary of the attribute “whether glasses are worn” in a latent space of the image generative network 1 according to the method provided in the embodiment. Then, an image to be edited and the decision boundary are input to a terminal 2, and the terminal 2 may remove the glasses in the image to be edited according to the decision boundary and the method provided in the abovementioned embodiment, and obtain a target image.

For another example, the images obtained by labelling the images generated by the image generative network 1 according to the category “glasses are worn” and the category “no glasses are worn” and the image to be edited are input to a terminal 3. The terminal 3 may determine the decision boundary of the attribute “whether glasses are worn” in the latent space of the image generative network 1 according to the method provided in the embodiment, then remove the glasses in the image to be edited according to the decision boundary and the method provided in the abovementioned embodiment, and obtain the target image.

Based on the embodiment, a decision boundary of any attribute in the latent space of the image generative network may be determined, to subsequently change a category of the attribute in an image generated by the image generative network based on the decision boundary of the attribute in the latent space of the image generative network.

Based on the methods provided in the abovementioned embodiments of the disclosure, the embodiments of the disclosure also provide some possible application scenarios.

In a possible implementation mode, a terminal (for example, a mobile phone, a computer and a tablet computer), under the condition of receiving an image to be edited input by a user and a target edit attribute, may firstly code the image to be edited, obtain a vector to be edited, then process the vector to be edited according to the method provided in the embodiments of the disclosure to change a category of the target edit attribute in the vector to be edited, obtain an edited vector, decode the edited vector and obtain a target image.

For example, the user inputs a self-portrait wearing glasses to a computer and simultaneously sends an instruction of removing the glasses in the self-portrait to the computer. The computer, after receiving the instruction, may process the self-portrait according to the method provided in the embodiments of the disclosure to remove the glasses in the self-portrait without influencing other image contents in the self-portrait, and obtain a self-portrait without glasses.

In another possible implementation mode, a user, when shooting a video through a terminal, may input a target edit attribute to the terminal (for example, a mobile phone, a computer and a tablet computer) and send an instruction of changing a category of the target edit attribute in a video stream shot by the terminal to the terminal. The terminal, after receiving the instruction, may code each frame of image in the video stream acquired by a camera, obtain multiple vectors to be edited, then process the multiple vectors to be edited according to the method provided in the embodiments of the disclosure, change the category of the target edit attribute in each vector to be edited, obtain multiple edited vectors, decode the multiple edited vectors and obtain multiple frames of target images, i.e., a target video stream.

For example, the user sends an instruction of regulating the age of a person in a video to 18 to a mobile phone and makes a video call with a friend through the mobile phone. In this case, the mobile phone may process each frame of images in a video stream acquired by the camera according to the embodiments of the disclosure and obtain a processed video stream. The person in the processed video stream is 18 years old.

In the embodiment, the method provided in the embodiments of the disclosure may be applied to the terminal to change the category of the attribute in the image input to the terminal by the user, the category of the attribute in the image may be changed rapidly based on the method provided in the embodiments of the disclosure, and the method provided in the embodiments of the disclosure may be applied to the terminal to change the category of the attribute in the video acquired by the terminal in real time.

It can be understood by those skilled in the art that, in the method of the specific implementation modes, the drafted sequence of each step does not mean a strict execution sequence and is not intended to form any limit to the implementation process and a specific execution sequence of each step should be determined by functions and probable internal logic thereof.

The methods of the embodiments of the disclosure are elaborated above, and devices of the embodiments of the disclosure will be provided below.

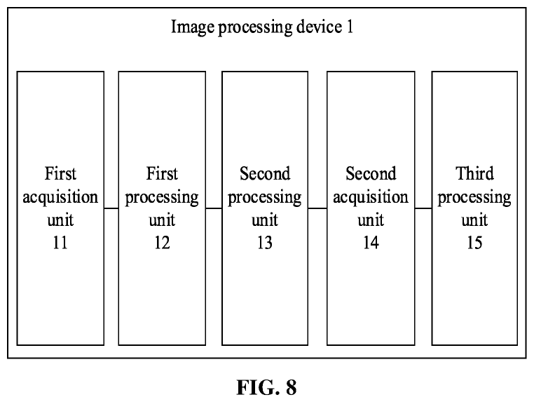

Referring to FIG. 8, FIG. 8 is a structure diagram of an image processing device according to an embodiment of the disclosure. The device 1 includes a first acquisition unit 11, a first processing unit 12 and a second processing unit 13.

The first acquisition unit 11 is configured to acquire a vector to be edited in a latent space of an image generative network and a first target decision boundary of a first target attribute in the latent space. The first target attribute includes a first category and a second category, the latent space is divided into a first subspace and a second subspace by the first target decision boundary, the first target attribute of vectors in the first subspace is of the first category, and the first target attribute of vectors in the second subspace is of the second category.

The first processing unit 12 is configured to move the vector to be edited in the first subspace to the second subspace, and obtain an edited vector.

The second processing unit 13 is configured to input the edited vector to the image generative network, and obtain a target image.

In a possible implementation mode, the first target decision boundary includes a first target hyperplane, and the first processing unit 11 is configured to acquire a first normal vector of the first target hyperplane as a target normal vector and move the vector to be edited in the first subspace to the second subspace along the target normal vector, and obtain the edited vector.

In another possible implementation mode, the image processing device 1 further includes a second acquisition unit 14. The first acquisition unit 11 is configured to, before the first normal vector of the first target hyperplane is acquired as the target normal vector, acquire a second target decision boundary of a second target attribute in the latent space. The second target attribute includes a third category and a fourth category, the latent space is divided into a third subspace and a fourth subspace by the second target decision boundary, the second target attribute of vectors in the third subspace is of the third category, the second target attribute of vectors in the fourth subspace is of the fourth category, and the second target decision boundary includes a second target hyperplane.

The second acquisition unit 14 is configured to acquire a second normal vector of the second target hyperplane, and is further configured to acquire a projected vector of the first normal vector in a direction perpendicular to the second normal vector.

In another possible implementation mode, the first processing unit 12 is configured to move the vector to be edited in the first subspace to the second subspace along the target normal vector and to be at a distance of a preset value from the first target hyperplane, and obtain the edited vector.

In another possible implementation mode, the first processing unit 12 is configured to, under the condition that the vector to be edited is in a subspace that the target normal vector points to, move the vector to be edited in the first subspace to the second subspace along a negative direction of the target normal vector and to be at the distance of the preset value from the first target hyperplane, and obtain the edited vector.

In another possible implementation mode, the first processing unit 12 is further configured to, under the condition that the vector to be edited is in a subspace that the negative direction of the target normal vector points to, move the vector to be edited in the first subspace to the second subspace along a positive direction of the target normal vector and to be at the distance of the preset value from the first target hyperplane, and obtain the edited vector.

In another possible implementation mode, the image processing device 1 further includes a third processing unit 15. The first acquisition unit 11 is configured to, before the vector to be edited in the first subspace is moved to the second subspace and the edited vector is obtained, acquire a third target decision boundary of a predetermined attribute in the latent space. The predetermined attribute includes a fifth category and a sixth category, the latent space is divided into a fifth subspace and a sixth subspace by the third target decision boundary, the predetermined attribute of vectors in the fifth subspace is of the fifth category, the predetermined attribute of vectors in the sixth subspace is of the sixth category, and the predetermined attribute includes a quality attribute.

The third processing unit 15 is configured to determine a third normal vector of the third target decision boundary.

The first processing unit 12 is configured to move a moved vector to be edited in the fifth subspace to the sixth subspace along the third normal vector. The moved vector to be edited is obtained by moving the vector to be edited in the first subspace to the second subspace.

In another possible implementation mode, the first acquisition unit 11 is configured to acquire an image to be edited and code the image to be edited and obtain the vector to be edited.

In the embodiment, the first target decision boundary is obtained by labelling images generated by an image generative network according to the first category and the second category, obtaining labelled images and inputting the labelled images to a classifier.

In some embodiments, functions or modules of the device provided in the embodiment of the disclosure may be configured to execute the method described in the above method embodiment and specific implementation thereof may refer to the descriptions about the method embodiment and, for simplicity, will not be elaborated herein.

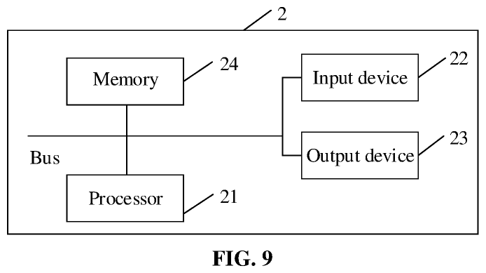

FIG. 9 is a hardware structure diagram of an image processing device according to an embodiment of the disclosure. The image processing device 2 includes a processor 21, a memory 24, an input device 22 and an output device 23. The processor 21, the memory 24, the input device 22 and the output device 23 are coupled through a connector. The connector includes various interfaces, transmission lines or buses, etc. No limits are made thereto in the embodiment of the disclosure. It is to be understood that, in each embodiment of the disclosure, coupling refers to interconnection implemented in a specific manner, including direct connection or direct connection through another device, for example, connection through various interfaces, transmission lines and buses.

The processor 21 may be one or more Graphics Processing Units (GPUs). Under the condition that the processor 21 is one GPU, the GPU may be a single-core GPU and may also be a multi-core GPU. Optionally, the processor 21 may be a processor set consisting of multiple GPUs, and multiple processors are coupled with one another through one or more buses. Optionally, the processor may also be a process of another type and the like. No limits are made in the embodiment of the disclosure.

The memory 24 may be configured to store a computer program instruction and various computer program codes including a program code configured to execute the solutions of the application. Optionally, the memory includes, but not limited to, a Random Access Memory (RAM), a Read-Only Memory (ROM), an Erasable Programmable ROM (EPROM) or a Compact Disc Read-Only Memory (CD-ROM). The memory is configured for related instructions and data.

The input device 22 is configured to input data and/or signals, and the output device 23 is configured to output data and/or signals. The output device 23 and the input device 22 may be independent devices and may also be integrated.

It can be understood that, in the embodiment of the disclosure, the memory 24 may not only be configured to store related instructions but also be configured to store related images. For example, the memory 24 may be configured to store a neural network to be searched acquired by the input device 22, or the memory 24 may also be configured to store a target neural network found by the processor 21 and the like. Data specifically stored in the memory is not limited in the embodiment of the disclosure.

It can be understood that FIG. 9 only shows a simplified design of the image processing device. During a practical application, the image processing device may further include other required components, including, but not limited to, any number of input/output devices, processors, memories and the like. All image processing devices capable of implementing the embodiments of the disclosure fall within the scope of protection of the application.

The embodiments of the disclosure also provide an electronic device, which includes an image processing device shown in FIG. 8. That is, the electronic device includes a processor, a sending device, an input device, an output device and a memory. The memory is configured to store a computer program code. The computer program code includes a computer instruction. When the processor executes the computer instruction, the electronic device executes the method of the abovementioned embodiments of the disclosure.

The embodiments of the disclosure also provide a processor, which is configured to execute the method of the abovementioned embodiments of the disclosure.

The embodiments of the disclosure also provide a computer-readable storage medium, in which a computer program is stored, the computer program including a program instruction and the program instruction being executed by a processor of an electronic device to enable the processor to execute the method of the abovementioned embodiments of the disclosure.

The embodiments of the disclosure also provide a computer program product, which includes a computer program instruction, the computer program instruction enabling a computer to execute the method of the abovementioned embodiments of the disclosure.

Those of ordinary skill in the art may realize that the units and algorithm steps of each example described in combination with the embodiments disclosed in the disclosure may be implemented by electronic hardware or a combination of computer software and the electronic hardware. Whether these functions are executed in a hardware or software manner depends on specific applications and design constraints of the technical solutions. Professionals may realize the described functions for each specific application by use of different methods, but such realization shall fall within the scope of the application.

Those skilled in the art may clearly learn about that specific working processes of the system, device and unit described above may refer to the corresponding processes in the method embodiment and will not be elaborated herein for convenient and brief description. Those skilled in the art may also clearly know that the embodiments of the disclosure are described with different focuses. For convenient and brief description, elaborations about the same or similar parts may be omitted in different embodiments, and thus parts that are not described or detailed in an embodiment may refer to records in the other embodiments.

In some embodiments provided by the application, it is to be understood that the disclosed system, device and method may be implemented in another manner. For example, the device embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The units described as separate parts may or may not be physically separated, and parts displayed as units may or may not be physical units, and namely may be located in the same place, or may also be distributed to multiple network units. Part or all of the units may be selected to achieve the purpose of the solutions of the embodiments according to a practical requirement.

In addition, each functional unit in each embodiment of the disclosure may be integrated into a processing unit, each unit may also physically exist independently, and two or more than two units may also be integrated into a unit.

The embodiments may be implemented completely or partially through software, hardware, firmware or any combination thereof. During implementation with the software, the embodiments may be implemented completely or partially in form of computer program product. The computer program product includes one or more computer instructions. When the computer program instruction is loaded and executed on a computer, the flows or functions according to the embodiments of the disclosure are completely or partially generated. The computer may be a universal computer, a dedicated computer, a computer network or another programmable device. The computer instruction may be stored in a computer-readable storage medium or transmitted through the computer-readable storage medium. The computer instruction may be transmitted from one website, computer, server or data center to another website, computer, server or data center in a wired (for example, a coaxial cable, an optical fiber and a Digital Subscriber Line (DSL)) or wireless (for example, infrared, radio and microwave) manner. The computer-readable storage medium may be any available medium accessible for the computer or a data storage device, such as a server and a data center, including one or more integrated available media. The available medium may be a magnetic medium (for example, a floppy disk, a hard disk and a magnetic tape), an optical medium (for example, a Digital Versatile Disc (DVD)), a semiconductor medium (for example, a Solid State Disk (SSD)) or the like.

It can be understood by those of ordinary skill in the art that all or part of the flows in the method of the abovementioned embodiments may be completed by instructing related hardware through a computer program, the program may be stored in a computer-readable storage medium, and when the program is executed, the flows of each method embodiment may be included. The storage medium includes: various media capable of storing program codes such as a U disk, a mobile hard disk, a ROM, a RAM, a magnetic disk or an optical disk.

1. An image processing method, comprising:
acquiring a vector to be edited in a latent space of an image generative network and a first target decision boundary of a first target attribute in the latent space, the first target attribute comprising a first category and a second category, the latent space being divided into a first subspace and a second subspace by the first target decision boundary, the first target attribute of vectors in the first subspace being of the first category, and the first target attribute of vectors in the second subspace being of the second category;
moving the vector to be edited in the first subspace to the second subspace, and obtaining an edited vector; and
inputting the edited vector to the image generative network, and obtaining a target image.

2. The method of claim 1, wherein the first target decision boundary comprises a first target hyperplane, and
wherein moving the vector to be edited in the first subspace to the second subspace, and obtaining the edited vector, comprises:
acquiring a first normal vector of a first target hyperplane as a target normal vector;
moving the vector to be edited in the first subspace to the second subspace along the target normal vector; and
obtaining the edited vector.

3. The method of claim 2, wherein before acquiring the first normal vector of the first target hyperplane as the target normal vector, the method further comprises:
acquiring a second target decision boundary of a second target attribute in the latent space, the second target attribute comprising a third category and a fourth category, the latent space being divided into a third subspace and a fourth subspace by the second target decision boundary, the second target attribute of vectors in the third subspace being of the third category, the second target attribute of vectors in the fourth subspace being of the fourth category and the second target decision boundary comprising a second target hyperplane;
acquiring a second normal vector of a second target hyperplane; and
acquiring a projected vector of the first normal vector in a direction perpendicular to the second normal vector.

4. The method of claim 2, wherein moving the vector to be edited in the first subspace to the second subspace along the target normal vector, and obtaining the edited vector, comprises:
moving the vector to be edited in the first subspace to the second subspace along the target normal vector and to be at a distance of a preset value from the first target hyperplane, and
obtaining the edited vector.

5. The method of claim 4, wherein moving the vector to be edited in the first subspace to the second subspace along the target normal vector and to be at the distance of the preset value from the first target hyperplane, and obtaining the edited vector, comprises:
under the condition that the vector to be edited is in a subspace that the target normal vector points to, moving the vector to be edited in the first subspace to the second subspace along a negative direction of the target normal vector and to be at the distance of the preset value from the first target hyperplane, and obtaining the edited vector.

6. The method of claim 5, further comprising:
under the condition that the vector to be edited is in a subspace that the negative direction of the target normal vector points to, moving the vector to be edited in the first subspace to the second subspace along a positive direction of the target normal vector and to be at the distance of the preset value from the first target hyperplane, and obtaining the edited vector.

7. The method of claim 1, wherein before moving the vector to be edited in the first subspace to the second subspace and obtaining the edited vector, the method further comprises:
acquiring a third target decision boundary of a predetermined attribute in the latent space, the predetermined attribute comprising a fifth category and a sixth category, the latent space being divided into a fifth subspace and a sixth subspace by the third target decision boundary, the predetermined attribute of vectors in the fifth subspace being of the fifth category, the predetermined attribute of vectors in the sixth subspace being of the sixth category, and the predetermined attribute comprising a quality attribute;
determining a third normal vector of the third target decision boundary; and
moving a moved vector to be edited in the fifth subspace to the sixth subspace along the third normal vector, wherein the moved vector to be edited is obtained by moving the vector to be edited in the first subspace to the second subspace.

8. The method of claim 1, wherein acquiring the vector to be edited in the latent space of the image generative network comprises:
acquiring an image to be edited;
coding the image to be edited; and
obtaining the vector to be edited.

9. The method of claim 8, wherein the first target decision boundary is obtained by: labelling images generated by the image generative network according to the first category and the second category, obtaining labelled images and inputting the labelled images to a classifier.

10. An electronic device, comprising:
a processor, and a memory, wherein the memory is configured to store instructions, which, when executed by the processor, cause the processor to carry out the following actions:
acquiring a vector to be edited in a latent space of an image generative network and a first target decision boundary of a first target attribute in the latent space, the first target attribute comprising a first category and a second category, the latent space being divided into a first subspace and a second subspace by the first target decision boundary, the first target attribute of vectors in the first subspace being of the first category and the first target attribute of vectors in the second subspace being of the second category;
moving the vector to be edited in the first subspace to the second subspace and obtaining an edited vector; and
inputting the edited vector to the image generative network and obtaining a target image.

11. The electronic device of claim 10, wherein the first target decision boundary comprises a first target hyperplane, and
wherein moving the vector to be edited in the first subspace to the second subspace, and obtaining the edited vector, comprises:
acquiring a first normal vector of the first target hyperplane as a target normal vector;
moving the vector to be edited in the first subspace to the second subspace along the target normal vector; and
obtaining the edited vector.

12. The electronic device of claim 11, wherein before the first normal vector of the first target hyperplane is acquired as the target normal vector, the actions further comprise:
acquiring a second target decision boundary of a second target attribute in the latent space, the second target attribute comprising a third category and a fourth category, the latent space being divided into a third subspace and a fourth subspace by the second target decision boundary, the second target attribute of vectors in the third subspace being of the third category, the second target attribute of vectors in the fourth subspace being of the fourth category and the second target decision boundary comprising a second target hyperplane;
acquiring a second normal vector of the second target hyperplane; and
acquiring a projected vector of the first normal vector in a direction perpendicular to the second normal vector.

13. The electronic device of claim 11, wherein moving the vector to be edited in the first subspace to the second subspace along the target normal vector, and obtaining the edited vector, comprises:
moving the vector to be edited in the first subspace to the second subspace along the target normal vector and to be at a distance of a preset value from the first target hyperplane, and,
obtaining the edited vector.

14. The electronic device of claim 13, wherein moving the vector to be edited in the first subspace to the second subspace along the target normal vector and to be at the distance of the preset value from the first target hyperplane, and obtaining the edited vector, comprises:
under the condition that the vector to be edited is in a subspace that the target normal vector points to, moving the vector to be edited in the first subspace to the second subspace along a negative direction of the target normal vector and to be at the distance of the preset value from the first target hyperplane, and obtaining the edited vector.

15. The electronic device of claim 14, wherein the actions further comprise:
under the condition that the vector to be edited is in a subspace that the negative direction of the target normal vector points to, moving the vector to be edited in the first subspace to the second subspace along a positive direction of the target normal vector and to be at the distance of the preset value from the first target hyperplane, and obtaining the edited vector.

16. The electronic device of claim 10, wherein before the vector to be edited in the first subspace is moved to the second subspace and the edited vector is obtained, the actions further comprise:
acquiring a third target decision boundary of a predetermined attribute in the latent space, the predetermined attribute comprising a fifth category and a sixth category, the latent space being divided into a fifth subspace and a sixth subspace by the third target decision boundary, the predetermined attribute of vectors in the fifth subspace being of the fifth category, the predetermined attribute of vectors in the sixth subspace being of the sixth category, and the predetermined attribute comprising a quality attribute;
determining a third normal vector of the third target decision boundary; and
moving a moved vector to be edited in the fifth subspace to the sixth subspace along the third normal vector, wherein the moved vector to be edited is obtained by moving the vector to be edited in the first subspace to the second subspace.

17. The electronic device of claim 10, wherein acquiring the vector to be edited in the latent space of the image generative network comprises:
acquiring an image to be edited and coding the image to be edited, and
obtaining the vector to be edited.

18. The electronic device of claim 17, wherein the first target decision boundary is obtained by labelling images generated by the image generative network according to the first category and the second category, obtaining labelled images, and inputting the labelled images to a classifier.

19. A non-transitory computer-readable storage medium, in which a computer program is stored, the computer program comprising program instructions, which, when executed by a processor of an electronic device, cause the processor to execute a method, comprising:
acquiring a vector to be edited in a latent space of an image generative network and a first target decision boundary of a first target attribute in the latent space, the first target attribute comprising a first category and a second category, the latent space being divided into a first subspace and a second subspace by the first target decision boundary, the first target attribute of vectors in the first subspace being of the first category, and the first target attribute of vectors in the second subspace being of the second category;
moving the vector to be edited in the first subspace to the second subspace, and obtaining an edited vector; and
inputting the edited vector to the image generative network, and obtaining a target image.

20. The non-transitory computer-readable storage medium of claim 19, wherein the first target decision boundary comprises a first target hyperplane, and moving the vector to be edited in the first subspace to the second subspace, and obtaining the edited vector, comprises:
acquiring a first normal vector of a first target hyperplane as a target normal vector;
moving the vector to be edited in the first subspace to the second subspace along the target normal vector; and
obtaining the edited vector.
